(19) United States
(12) Patent Application Publication
(10) Pub. No.: US 2008/0292380 A1
(43) Pub. Date: Nov. 27, 2008

(54) APPARATUS AND METHOD FOR DATING ITEMS TO BE REFRIGERATED OR STORED

(76) Inventor: Raymond Diulio, Palm Harbor, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/752,316

(22) Filed: May 23, 2007

(51) Int. Cl. B41J 11/44

(52) U.S. Cl. 400/76

(57) ABSTRACT

An apparatus and associated method for dating items to be refrigerated or stored, wherein the apparatus includes a display, controller buttons for selecting a desired label to be printed, a built-in printer capable of printing labels exiting from a cartridge holding the labels. The apparatus includes the ability to print the current date and time along with text indicia designating certain food types or symbol indicia representative of various food types such as beef, poultry, pork and fish.

### FIELD OF THE INVENTION

The invention relates to convenient device for labeling and in particular, dating food items to be refrigerated and other items to be stored.

### BACKGROUND OF THE INVENTION

There are devices known in the art related to label makers where the desired indicia on a label can be typed in using a keyboard and the label can then be printed with the desired indicia. Typically, these devices are relatively complex due to the flexibility of printing almost any desired indicia on a label. The labels are in the form of a cartridge available commercially through most office supply companies. In some cases, computer illiterate or challenged people can have a difficult time operating what is effectively a miniature computer/keyboard combination with a built-in printer to print the labels.

What is needed is a more convenient, much simpler to operate device that can be conveniently mounted on a desired household article, such as a refrigerator, or on a wall section next to an appliance, where the device is pre-programmed to present a calendar date and a label with a desired indicia or symbol together with the date and/or time can be generated, thereby allowing the homeowner to place a label on the item being refrigerated or stored.

### SUMMARY OF THE INVENTION

As can be surmised from above, the invention is such a more convenient, much simpler to operate device that can be conveniently mounted on a desired household article, such as a refrigerator, or on a wall section next to an appliance. The device pre-programmed to present a calendar date and optionally time and a label with a desired indicia or symbol together with the date and time, if applicable, can be generated, thereby allowing the homeowner to place a label on the item being refrigerated or stored, with identifying indicia on the label.

The device has a plurality of buttons or activation switches, also hereinafter referred to as the controller or controller portion of the device, that when activated, print out a label. For example, one button may be programmed to print a date and indicia such as “FISH” or a button to print a date and indicia that has a character symbol representing a fish. Another indicia example may be the word “BEEF” or a symbol representing beef such as a cow image. Another indicia example may be the word “POULTRY” or a symbol representing poultry such as a bird, or hen image. Another indicia example may be the word “PORK” or a symbol representing a pork such as a pig image. Another option may be to have a button that when activated prints no indicia except for the date and possible combination of date and time. This latter button would effectively be a blank button.

Preferably, the device will have five buttons or other means of activating the desired indicia to be printed on the label. One would be blank as described above and the remaining four would correspond to a choice for beef, poultry, pork and fish. The blank button could be activated when other miscellaneous items are to be refrigerated or stored, such as soup, spaghetti sauce, vegetables and the like.

The device can also be used for dating other non-refrigerated items as well where a date is desired. Again, in this case, the blank button would be used. The printed label with the date/time only could be further optionally annotated that the content is “SOUP”, “NUTS”, “SAUCE”, “VEGIES”, “CORN”, “PEAS”, “PICTURES”, “DOCUMENTS”, etc.

Preferably, the device has means for displaying at least the calendar date, such as an LCD screen. It should also have an easy loadable cassette compartment for pre-loading the label cartridge and it should be battery operated.

Typically, the device is kept in a holder that is mountable to an appliance facia such as a refrigerator door or side using a magnet or a hook and loop fastener device such as that made by the VELCRO® Corporation. Alternatively, the holder can be screwed or otherwise fastened to a convenient location such as a wall or wall trim or cabinet surface. The holder is effectively a cradle with a generally open front to facilitate viewing the display screen and the desired print activation buttons.

As with most of these electronic devices, the device includes micro-processing means that is pre-programmed to store the desired parameters to be printable when specific buttons are activated and to maintain a calendar date and if desired, time. It is understood that one skilled in the art as a programmer, given the parameters to be generated and the printable function included within the device can develop the necessary software to operate the device.

The convenience of such a device is advantageous to the household. When a container of beef has to be frozen, simply pushing a button on the device designated for the beef label generates a label with at least the date on it and either text indicia chosen to represent beef or a symbol indicia chosen to represent beef. Optionally, time could also be programmed to print out on the label as well. The labeling is fast, convenient, simple (the pushing of one button) and allows for rapid identification of the content of the container being refrigerated or stored. If a salsa is being refrigerated or stored in the freezer, then the blank button can be activated to print a label with date/time indicia and the homeowner can optionally, using a pen, print the text “Salsa” on the label.

In an alternative embodiment, the invention includes an extended downwardly directed back portion extending downward from the back side of the holder for the apparatus wherein a front side of the extended downwardly directed back portion is adapted to hold a note pad. This is a convenient tool for a homeowner to use to note grocery items that need to be picked up at the store. The note pad can be placed on the back portion in a number of ways known in the art such as by using a clip riveted to the back portion (clipboard type) or using hook and loop fasteners or using a magnet type of attachment, etc.

The device will have means typical of such computerized electronic devices to set the current date and optionally, the current time. This can be done using the controller portion of the device using buttons independent of the buttons used for activating the printing of a label. The time and date setting feature can be incorporated on the front face, side face or back side of the device.

### BRIEF DESCRIPTION OF THE DRAWINGS

In the accompanying drawings:

FIG. 1 is a perspective conceptual view of one embodiment of the invention;

FIG. 2 is a back side view of FIG. 1 depicting one method of locating the holder on a surface of an appliance or other surface using one or more magnets;

FIG. 3 is an exploded view of the embodiment of FIG. 1;

FIG. 4 is a view of the labeling device of the present invention as depicted in FIG. 1 with the print out of a typical example of a label;

FIG. 5 is a view similar to FIG. 1 depicting additional data and symbols to be printed on an eventual label;

FIG. 6 is a depiction of another method of locating the invention to a surface using hook and loop fasteners;

FIG. 7 is a perspective conceptual depiction of another embodiment of the invention further adding an extended portion for a note pad;

FIGS. 8A-8J are representative samplings or examples of the types of data or information that the present invention can be programmed to print out; and

FIG. 9 is a conceptual schematic of the operating features and necessary components related to the operation of the invention.

### DETAILED DESCRIPTION OF THE INVENTION

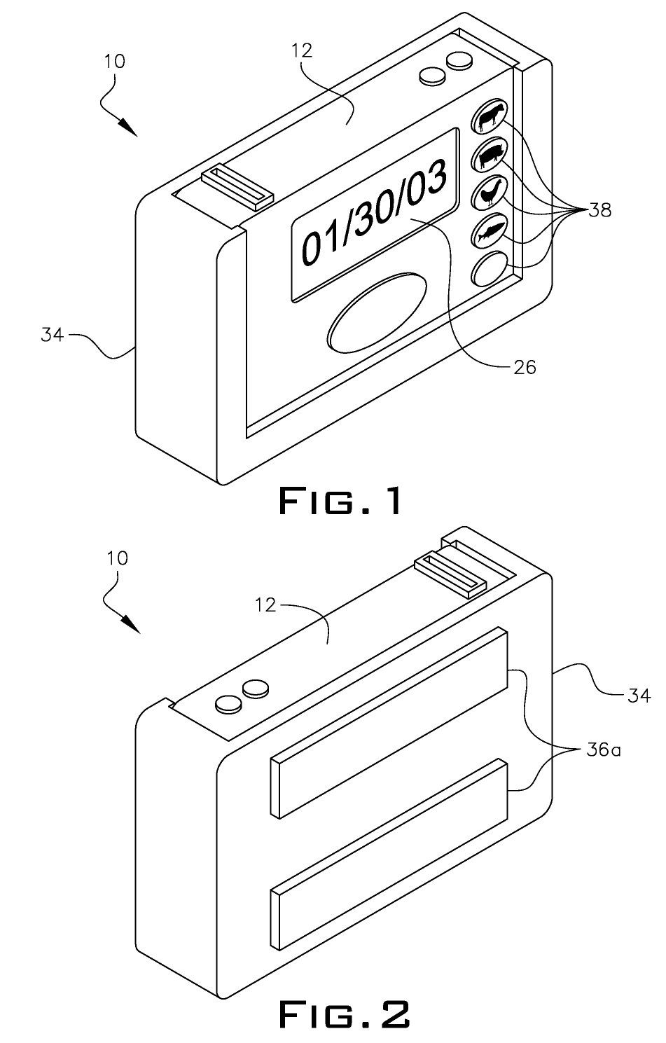

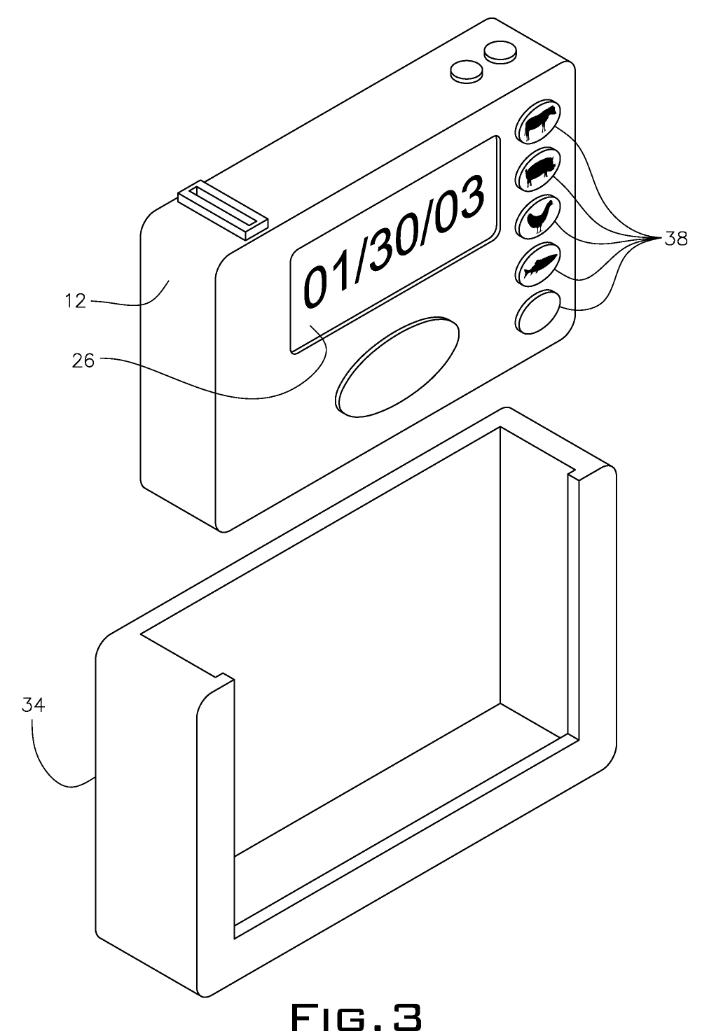

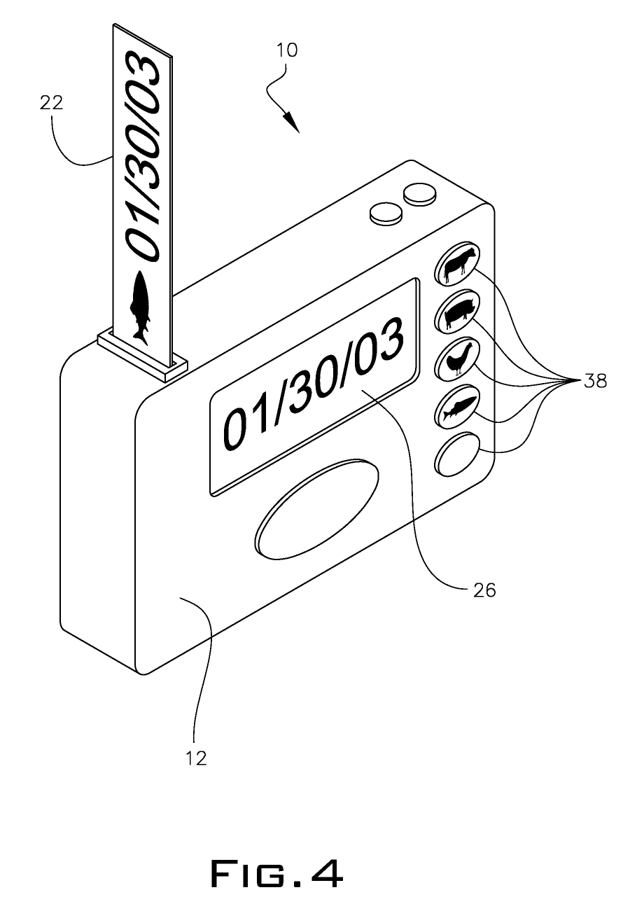

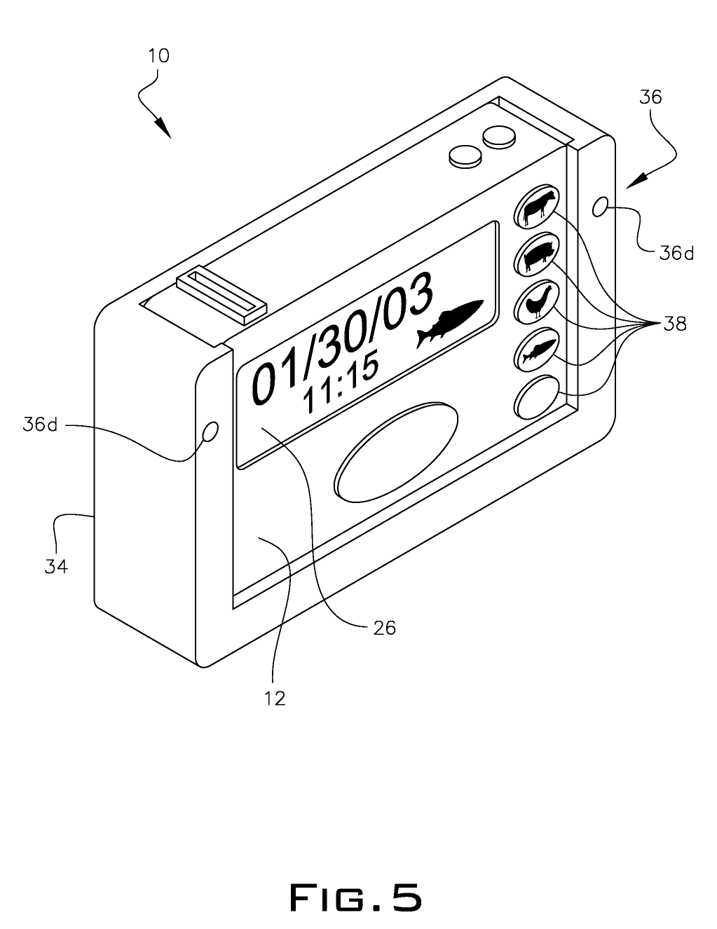

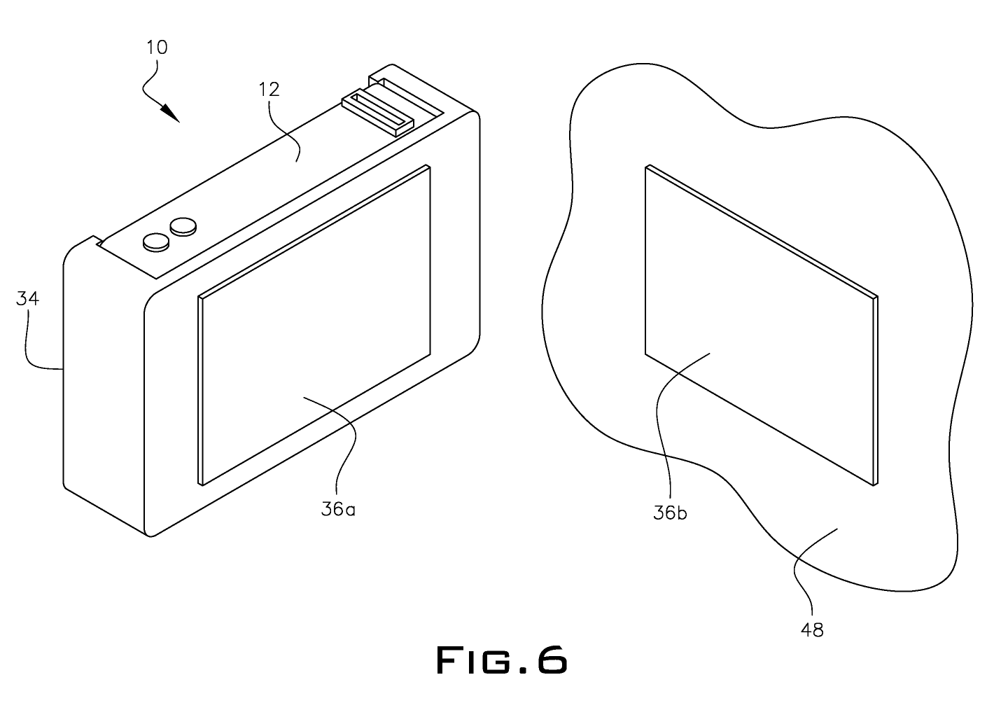

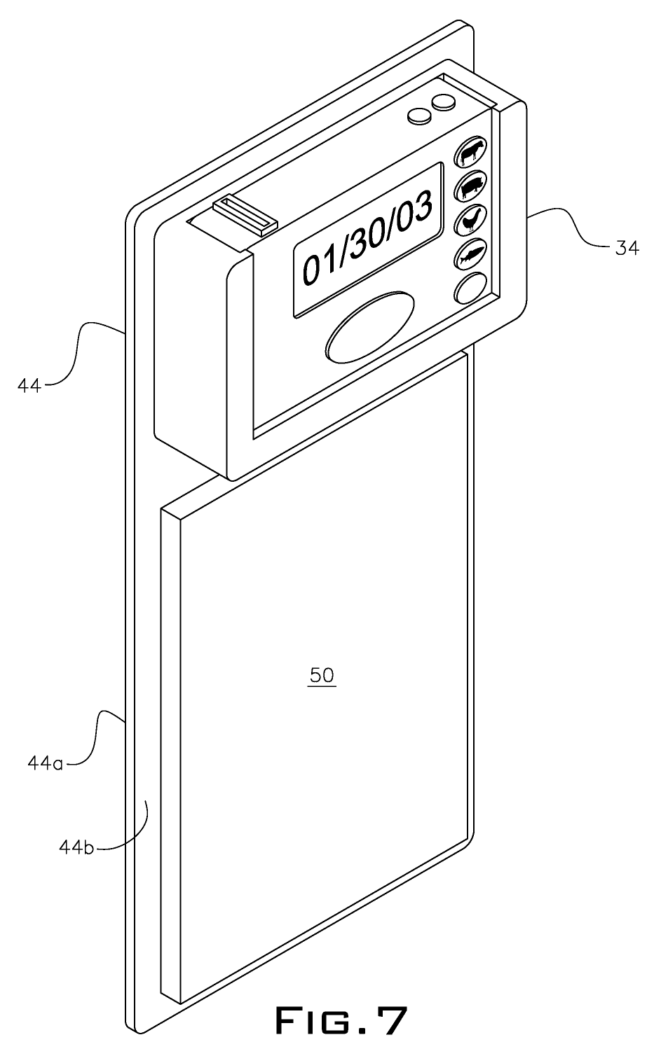

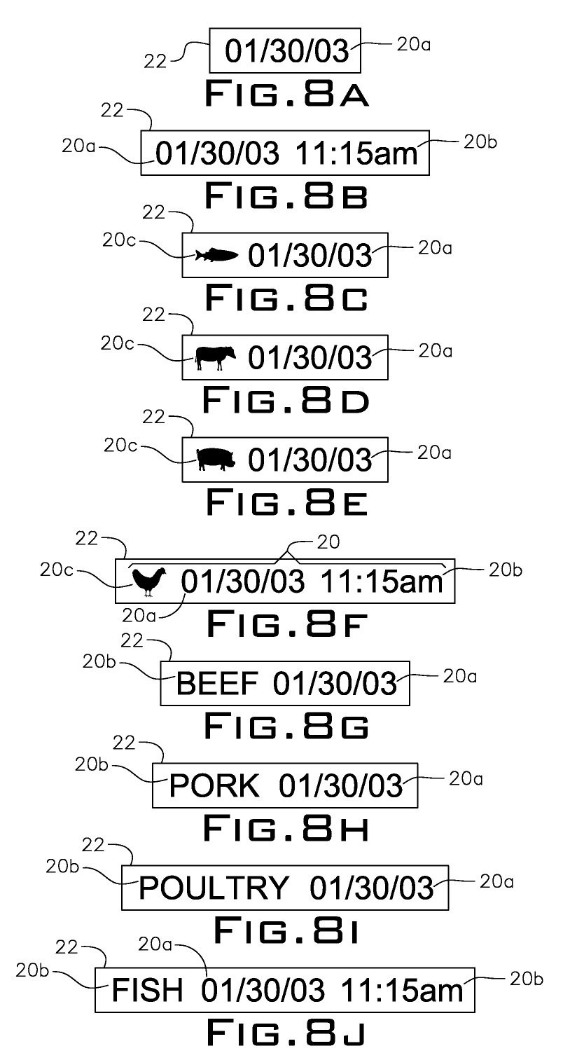

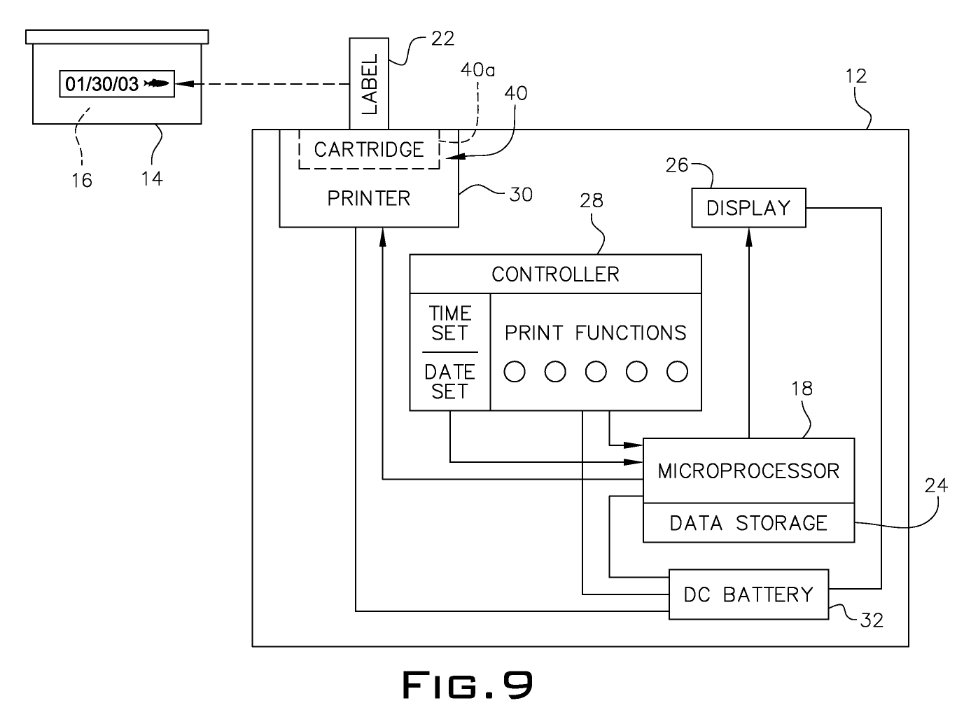

Referring now to the drawings, in particular FIGS. 1-6 and FIGS. 8A-8J and 9, the invention 10 is an apparatus 12 for recording a date on a container 14 for storing food or other items 16 to be stored. The apparatus or device comprises micro-processing means 18 for programming selected calendar date data 20a and desired indicia 20b and/or symbols 20c representative of a content 16 (food or item to be stored) inside a container 14 to be labeled using a label 22 printed from the apparatus 12. Typical of any electronic device using a micro-processor 18 with the ability to print, the apparatus includes data storage means 24 for storing said calendar date data 20a and said desired indicia 20b and/or symbols 20c representative of said content 16 inside said container 12 to be labeled. The current data is displayed on a screen 26, which is in communication with the micro-processor 18. Typical displayed data includes a current date 20a or a combination of the current date 20a and a current time indicia 20b. In a preferred embodiment, the screen display is a liquid crystal display (LCD).

The apparatus further has controller means 28 for activating the printing of a selected label 22 with predetermined indicia 20 to be printed on the selected label 22, and printer means 30 for printing the selected label 22 with the predetermined indicia 20 to be printed on the selected label 22.

Typical of most electronic devices, the apparatus is powered by DC battery means 32. It can be multiple batteries such as AA or AAA batteries or single batteries such as a 9-volt battery or a flat washer shape battery such as those used in computers and watches. One skilled in the art can size the battery based on the power requirements to display the data and to print the labels as well as the desired compactness of the apparatus.

The invention 10 includes a holder 34 for holding the device 12 at a desired location. The holder 34 further comprising means 36 for attaching the holder 34 to the desired location.

The controller means 28 for activating the printing of the selected label 22 with the predetermined indicia 20 to be printed on the selected label 22 comprises a plurality of predetermined activation switches 38 designated for predetermined contents 16 for which the selected label 22 is to be printed. As described above, these switches are typically push buttons 38 as shown conceptually on the drawings.

The plurality of predetermined activation switches 38 designated for predetermined contents 16 for which the selected label 22 is to be printed comprises designated independent activation switches 38 (5 shown in the drawings by way of example). One is designated for a beef product, a poultry product, a pork product, and a fish product and a fifth one is designated as a generic option (left blank) for printing a date/time label for miscellaneous items such as soup, sauce, or other items to be stored whether in a freezer, refrigerator, or elsewhere.

The apparatus 12 further comprises a compartment for pre-loading a cartridge 40a containing a pre-selected number of blank labels 22 for use with said apparatus 12. As mentioned above, the cartridges 40a holding the labels 22 are readily available commercially in office supply retail stores. When an activation switch 38 is depressed, the appropriate label 22 is printed and is exited from the device 12 for taking and applying to the container 14.

The holder 34 can be attached to an appliance or wall or other location in a number of ways known in the art. One preferred way is to provide a laminate magnet 36a adhesively attached to a back side 44 of the holder 34 or a hook and loop fastener means 36b,36c wherein one side 36b is adhesively attachable to the back side 44 of the holder and a corresponding opposing side 36c is adhesively attachable to a desired location, such as an appliance panel 48. Another alternative is to use spaced-apart holes or apertures 36d where a screw or wall anchor (not shown as such fasteners and anchor systems if needed are well known in the art) can be inserted through the hole 36d for mounting the holder 34.

In an alternative embodiment as depicted by way of example in FIG. 7, the invention is formed in a clipboard type of configuration, the holder 34 further comprises an extended downwardly directed back portion 44a wherein a front side 44b of said extended downwardly directed back portion 44a is adapted to hold a note pad 50. Again, the note pad 50 itself can be attached in a number of ways such as using a clipboard type of clip, which is well known in the art or using magnets or hook and loop type of fasteners.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. An apparatus for recording a date on a container for storing food or other items to be stored comprising:
micro-processing means for programming selected calendar date data and desired indicia and/or symbols representative of a content inside a container to be labeled;
data storage means for storing said calendar date data and said desired indicia and/or symbols representative of said content inside said container to be labeled;
display means in communication with said micro-processing means for displaying a current date or a combination of said current date and a current time;
controller means for activating the printing of a selected label with predetermined indicia to be printed on said selected label;
printer means for printing said selected label with said predetermined indicia to be printed on said selected label;
DC battery means for supplying a power source for operating the apparatus; and
holder means for holding said apparatus at a desired location, said holder means further comprising means for attaching said holder means to said desired location;
wherein said controller means for activating the printing of said selected label with said predetermined indicia to be printed on said selected label comprises a plurality of predetermined activation switches designated for predetermined contents for which said selected label is to be printed.

2. The apparatus according to claim 1, wherein said plurality of predetermined activation switches designated for predetermined contents for which said selected label is to be printed comprises designated independent activation switches for a beef product, a poultry product, a port product, and a fish product.

3. The apparatus according to claim 2, further comprising a designated activation switch for printing a generic label with indicia corresponding to said current date or said combination of said current date and said current time.

4. The apparatus according to claim 1, wherein said display means comprises a LCD screen.

5. The apparatus according to claim 1, further comprising means for pre-loading a cartridge containing a pre-selected number of blank labels for use with said apparatus.

6. The apparatus according to claim 1, wherein said means for attaching said holder means to said desired location comprises one of a laminate magnet adhesively attached to a back side of said holder means or a hook and loop fastener means wherein one side of said hook and loop fastener means is adhesively attachable to said back side of said holder means and a corresponding opposing side of said hook and loop fastener means is adhesively attachable to said desired location.

7. The apparatus according to claim 1, wherein said means for attaching said holder means to said desired location comprises at least two spaced-apart apertures for directly screw-mounting said holder means to said desired location.

8. The apparatus according to claim 1, wherein said holder means further comprises an extended downwardly directed back portion wherein a front side of said extended downwardly directed back portion is adapted to hold a note pad.

9. A method for dating items to be refrigerated or stored comprising:
providing an apparatus for recording a date on a container for storing food or other items to be stored, the apparatus comprising:
micro-processing means for programming selected calendar date data and desired indicia and/or symbols representative of a content inside a container to be labeled;
data storage means for storing said calendar date data and said desired indicia and/or symbols representative of said content inside said container to be labeled;
display means in communication with said micro-processing means for displaying a current date or a combination of said current date and a current time;
controller means for activating the printing of a selected label with predetermined indicia to be printed on said selected label;
printer means for printing said label with said predetermined indicia to be printed on said label;
DC battery means for supplying a power source for operating the apparatus; and
holder means for holding said apparatus at a desired location, said holder means further comprising means for attaching said holder means to said desired location;
wherein said controller means for activating the printing of said selected label with said predetermined indicia to be printed on said selected label comprises a plurality of predetermined activation switches designated for predetermined contents for which said selected label is to be printed;
selecting a desired one of said predetermined activation switches and printing said selected label with predetermined indicia; and
applying said printed selected label to said container.

10. The method according to claim 9, wherein said plurality of predetermined activation switches designated for predetermined contents for which said selected label is to be printed comprises designated independent activation switches for a beef product, a poultry product, a pork product, and a fish product.

11. The method according to claim 10, further comprising providing a designated activation switch for printing a generic label with indicia corresponding to said current date or said combination of said current date and said current time.

12. The method according to claim 9, wherein said display means comprises a LCD screen.

13. The method according to claim 9, further comprising providing means for pre-loading a cartridge containing a pre-selected number of blank labels for use with said apparatus.

14. The method according to claim 9, wherein said means for attaching said holder means to said desired location comprises one of a laminate magnet adhesively attached to a back side of said holder means or a hook and loop fastener means wherein one side of said hook and loop fastener means is adhesively attachable to said back side of said holder means and a corresponding opposing side of said hook and loop fastener means is adhesively attachable to said desired location.

16. The method according to claim 9, wherein said means for attaching said holder means to said desired location comprises at least two spaced-apart apertures for directly screw-mounting said holder means to said desired location.

17. The method according to claim 9, wherein said holder means further comprises an extended downwardly directed back portion wherein a front side of said extended downwardly directed back portion is adapted to hold a note pad.
